(19) United States
(12) Patent Application Publication
(10) Pub. No.: US 2014/0048748 A1
(43) Pub. Date: Feb. 20, 2014

(54) GRAPHENE NANORIBBON COMPOSITES AND METHODS OF MAKING THE SAME

(71) Applicants: James M. Tour, Bellaire, TX (US); Yu Zhu, Housto, TX (US); Abdul-Rahman O. Raji, Houston, TX (US)

(72) Inventors: James M. Tour, Bellaire, TX (US); Yu Zhu, Housto, TX (US); Abdul-Rahman O. Raji, Houston, TX (US)

(73) Assignee: William Marsh Rice University, Houston, TX (US)

(21) Appl. No.: 13/985,458

(22) PCT Filed: Feb. 13, 2012
(86) PCT No.: PCT/US12/24846

§ 371 Date: Nov. 5, 2013

Related U.S. Application Data
(60) Provisional application No. 61/442,519, filed on Feb. 14, 2011.

(51) Int. Cl. C09J 9/02

(52) U.S. Cl. CPC C09J 9/02
USPC 252/511

(57) ABSTRACT

In some embodiments, the present invention provides graphene nanoribbon composites that include a polymer matrix and graphene nanoribbons that are dispersed in the polymer matrix. In more specific embodiments, the polymer matrix of the composite is an epoxy matrix, and the graphene nanoribbons of the composite include functionalized graphene nanoribbons. In further embodiments, the composites of the present invention further comprise metals, such as tin, copper, gold, silver, aluminum and combinations thereof. Additional embodiments of the present invention pertain to methods of making the graphene nanoribbon composites of the present invention. In some embodiments, such methods include mixing graphene nanoribbons with polymer precursors to form a mixture, and then curing the mixture to form the composite.

### CROSS-REFERENCE TO RELATED APPLICATIONS

This application claims priority to U.S. Provisional Patent Application No. 61/442,519, filed on Feb. 14, 2011. The entirety of the above-identified provisional application is incorporated herein by reference.

### STATEMENT REGARDING FEDERALLY SPONSORED RESEARCH

This invention was made with government support under Grant No. N000014-09-1-066, awarded by the Department of Defense through the United States Navy Office of Naval Research; and Grant No. FA9550-09-1-0581, awarded by the Department of Defense through the United States Air Force Office of Scientific Research. The government has certain rights in the invention.

### BACKGROUND OF THE INVENTION

Present day adhesives have numerous limitations. Such limitations include poor conductivity, limited adhesiveness, and limited resistance to hostile environments. Therefore, a need exists for the development of improved adhesives that are conductive, and useable in various environments where conductivity is essential.

### BRIEF SUMMARY OF THE INVENTION

In some embodiments, the present invention provides graphene nanoribbon composites that are adhesive, electrically conductive, and useable in various environments. Such composites generally include a polymer matrix and graphene nanoribbons that are dispersed in the polymer matrix.

In some embodiments, the graphene nanoribbons include at least one of functionalized graphene nanoribbons, pristine graphene nanoribbons, doped graphene nanoribbons, graphene oxide nanoribbons, reduced graphene oxide nanoribbons and combinations thereof. In some embodiments, the graphene nanoribbons include stacked graphene nanoribbons.

In some embodiments, the polymer matrix of the composite includes at least one of polyurethanes, epoxy resins, polyimides, nylons, polyesters, acrylic resins, polycyanoacrylates, polystyrenes, polybutadienes, synthetic rubbers, natural rubbers, and combinations thereof. In more specific embodiments, the polymer matrix of the composite is an epoxy polymer matrix, and the graphene nanoribbons in the composite include functionalized graphene nanoribbons. In further embodiments, the composites of the present invention further comprise metals, such as tin, copper, gold, silver, aluminum and combinations thereof.

Additional embodiments of the present invention pertain to methods of making the graphene nanoribbon composites of the present invention. In some embodiments, such methods include mixing graphene nanoribbons with polymer precursors to form a mixture, and then curing the mixture to form the composite.

The composites of the present invention provide numerous applications. For instance, in some embodiments, the composites of the present invention can be used as adhesives to bond computer chips.

### BRIEF DESCRIPTION OF THE FIGURES

FIG. 1 illustrates schemes for the synthesis of various graphene nanoribbons with edge organic addends, starting from multi-walled carbon nanotubes.

FIG. 2 shows images of graphene nanoribbon stacks. FIGS. 2A and 2B show scanning electron microscopy (SEM) images of the graphene nanoribbon stacks. FIG. 2C shows a transmission electron microscopy (TEM) image of the graphene nanoribbon stacks.

FIG. 3 provides pictorial representations of various graphene nanoribbon composites. FIG. 3A shows pictures of graphene nanoribbon-epoxy composites with Pt contacts on top and bottom. FIG. 3B shows pictures of graphene nanoribbon-epoxy composites that are tightly bonded to glass.

### DETAILED DESCRIPTION OF EXEMPLARY EMBODIMENTS

It is to be understood that both the foregoing general description and the following detailed description are exemplary and explanatory only, and are not restrictive of the invention, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that comprise more than one unit unless specifically stated otherwise.

The section headings used herein are for organizational purposes only and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

By way of background, conductive adhesives generally refer to polymers that contain conductive materials, such as tin, copper, graphite, gold, and silver. Such conductive adhesives tend to be expensive. This in turn limits their usage in many applications. Furthermore, conductive adhesives have limited resistance to hostile environments. The existing conductive adhesives also have limited conductivity, limited adhesiveness, and limited processibility. Therefore, a need exists for the development of improved adhesives that are more conductive, more adhesive, more processible, and useable in various environments. The present invention addresses these needs by providing graphene nanoribbon composites and methods of making them.

Composites

In one aspect, the present invention provides graphene nanoribbon composites (hereinafter composites). In some embodiments, such composites are adhesive, electrically conductive, processible, and useable in various environments. The composites of the present invention generally include a polymer matrix and graphene nanoribbons that are dispersed in the polymer matrix.

In some embodiments, the composites of the present invention may also include metals. In addition, the composites of the present invention may be associated with various substrates. As set forth in more detail below, various graphene nanoribbons, polymers, metals, and substrates may be associated with the composites of the present invention.

Graphene Nanoribbons

The composites of the present invention may include one or more types of graphene nanoribbons (GNRs). Non-limiting examples of suitable graphene nanoribbons include functionalized graphene nanoribbons, pristine graphene nanoribbons, doped graphene nanoribbons, and combinations thereof. In more specific embodiments, the graphene nanoribbons may include graphene oxide nanoribbons, reduced graphene oxide nanoribbons (also referred to as chemically converted graphene nanoribbons), and combinations thereof. In further embodiments, the graphene nanoribbons can be graphene nanoribbons derived from exfoliated graphite, graphene nanoflakes, or split carbon nanotubes (such as multi-walled carbon nanotubes).

In various embodiments, the graphene nanoribbons of the present invention may be in stacked form. In some embodiments, the stacked graphene nanoribbons may contain from about 2 layers to about 50 layers of graphene nanoribbons.

In some embodiments, the composites of the present invention may also include one or more layers of graphene along with the graphene nanoribbons. Such graphenes may include, without limitation, pristine graphene, doped graphene, graphene oxide, reduced graphene oxide, chemically converted graphene, functionalized graphene and combinations thereof.

In further embodiments, the graphene nanoribbons of the present invention may be derived from split carbon nanotubes. In various embodiments, the split carbon nanotubes may be derived from single-walled carbon nanotubes, multi-walled carbon nanotubes, double-walled carbon nanotubes, ultrashort carbon nanotubes, pristine carbon nanotubes, functionalized carbon nanotubes, and combinations thereof. In more specific embodiments, the graphene nanoribbons of the present invention are derived from split multi-walled carbon nanotubes. In additional embodiments, the graphene nanoribbons of the present invention may include mixtures of graphene nanoribbons and carbon nanotubes.

In some embodiments, the graphene nanoribbons of the present invention may be functionalized by various functional groups. Examples of suitable functional groups include, without limitation, polyethylene glycols, aryl groups, hydroxyl groups, carboxyl groups, phenol groups, amine groups, ether-based functional groups, phosphate groups, phosphonic acids (e.g., RPO(OH)₂, where R is a carbon group linked to the graphene scaffold) and combinations thereof. In some embodiments, the graphene nanoribbons of the present invention are functionalized with a polymer, such as a vinyl polymer or a polyethylene glycol. In more specific embodiments, the graphene nanoribbons of the present invention are functionalized with a polyethylene glycol, such as triethylene glycol di(p-toluenesulfonate), polyethylene glycol methyl ether tosylate, and the like. In some embodiments, polyethylene glycol functional groups on graphene nanoribbons can be further hydrolyzed to remove most or all of any tosylate groups in order to afford terminal hydroxyl groups.

In various embodiments, the graphene nanoribbons of the present invention may also be associated with one or more surfactants. In further embodiments, the graphene nanoribbons may be doped with various additives. In some embodiments, the additives may be one or more heteroatoms of B, N, O, Al, Au, P, Si or S. In more specific embodiments, the doped additives may include, without limitation, melamine, carboranes, aminoboranes, phosphines, aluminum hydroxides, silanes, polysilanes, polysiloxanes, sulfides, thiols, and combinations thereof. In more specific embodiments, the graphene nanoribbons may be HNO₃ doped and/or AuCl₃ doped.

In more specific embodiments, the graphene nanoribbons of the present invention include functionalized graphene nanoribbons. In some embodiments, graphene nanoribbons have an aspect ratio in length-to-width greater than or equal to 2, and preferably greater than 10, and more preferably greater than 100. In some embodiments, the graphene nanoribbons have an aspect ratio greater than 1000.

In various embodiments, the use of graphene nanoribbons in composites provides various advantages over the use of sheet-like or disc-like forms of graphenes. For instance, graphene nanoribbons have higher length-to-width aspect ratios than many graphene sheets (e.g., the length-to-width aspect ratios of many graphene sheets are less than 2). Such higher aspect ratios can obviate the need for more material to form a percolative network (an electrical current pathway). Thus, by utilizing graphene nanoribbons rather than graphene sheets or discs, one can obtain composites with a percolative network at lower graphene concentrations (e.g., 0.1% to 5% of the composite weight).

Furthermore, graphene nanoribbons are more processible and electrically conductive within composites than graphene sheets or discs. In particular, graphene nanoribbons permit easier processing than sheet-like or disc-like graphene structures because they can obtain similar electronic properties as the graphene structures at lower concentrations.

In addition, a more facile shear-induced alignment of the graphene nanoribbons can be obtained within composites. Moreover, graphene nanoribbons can have very high levels of edge functionalization when prepared by the splitting of carbon nanotubes. Such high levels of edge functionalization (without functionalizations on the planes) may not be attainable from disc-like or sheet-like graphene structures. In addition, the functionalization can permit better processibility and lower loadings for the same electrical and mechanical performance.

Polymer Matrix

The composites of the present invention may also include various polymer matrices. A polymer matrix generally refers to a network or array of polymers. Non-limiting examples of suitable polymers that can be utilized in the polymer matrices of the present invention include polyurethanes, epoxy resins, polyimides, nylons, polyesters, acrylic resins, polycyanoacrylates, polystyrenes, polybutadienes, synthetic rubbers, natural rubbers and combinations thereof.

In more specific embodiments, the polymer matrices of the present invention are epoxy polymer matrices (i.e., matrices that include an epoxy resin). An example of a suitable epoxy resin is Aeromarine Product No. 300. Epoxy resins provide good heat and chemical resistance. Furthermore, epoxies are generally in the form of viscous liquids, rendering them processible by low cost wet methods, such as blade coating and printing.

Metals

In various embodiments, the composites of the present invention also include metals. Non-limiting examples of suitable metals include tin, copper, gold, silver, aluminum and combinations thereof.

In some embodiments, the metals may include metal particles of various sizes. In some embodiments, the metal particles may be less than about 100 nanometers in any of their dimensions. In some embodiments, the metal particles may be less than about 1 micron in any of their dimensions. In some embodiments, the metal particles may be less than about 100 microns in any of their dimensions. In some embodiments, the metal particles are in the form of rods, such as rods with a length-to-width aspect ratio greater than 2.

Arrangements

The components of the composites of the present invention can have various arrangements. For instance, in some embodiments, graphene nanoribbons are dispersed in the polymer matrix in a random, aligned or disordered manner. In some embodiments, the graphene nanoribbons are intertwined with the polymer matrix. In some embodiments, the graphene nanoribbons may be scattered in the polymer matrix. In other arrangements, the graphene nanoribbons may be dispersed in the polymer matrix with a significant alignment order. In some embodiments, such alignment order can be attained through mechanical shear forces. In further embodiments, the graphene nanoribbons may be arranged or dispersed as stacks within a composite. In some embodiments, the graphene nanoribbons may be in stacks that range from about 2 layers to about 50 layers.

The composites of the present invention can also have various shapes. For instance, in some embodiments, the composites of the present invention may have a non-planar shape, such as a dome. In additional embodiments, the composites of the present invention may have a planar shape. In further embodiments, the composites of the present invention may be flexible at room temperature. In additional embodiments, the composites of the present invention may be rigid at room temperature. In some embodiments, the composites of the present invention may be arranged in the form of a tape or a thin film. In some embodiments, the composites may be conformal such that they follow the shape of a host surface to which they are interfaced.

Substrates

Composites of the present invention may be associated with various substrates. Such substrates may include, without limitation, glass, quartz, boron nitride, alumina, silicon, plastics, polymers, silicon oxides, and combinations thereof. More specific examples of suitable substrates include ceramics, polyimides, polytetrafluoroethylenes, polyethylene terephthalate (PET), solid oxides, and the like.

Composite Variations

In sum, various graphene nanoribbons, polymers, metals, and substrates at various concentrations may be associated with the composites of the present invention. For instance, in more specific embodiments, the composites of the present invention may include an epoxy polymer matrix and functionalized graphene nanoribbons (e.g., graphene nanoribbons functionalized with polyethylene glycols).

In some embodiments, the graphene nanoribbon content in the composites may be from about 1% of the composite weight to about 50% of the composite weight. In some embodiments, the graphene nanoribbon content in the composites may be from about 0.1% of the composite weight to about 0.2% of the composite weight. As set forth in more detail below, various methods may also be utilized to form the composites of the present invention.

Methods of Making Composites

Further embodiments of the present invention pertain to methods of making the aforementioned graphene nanoribbon composites. In some embodiments, such methods include mixing graphene nanoribbons with polymer precursors to form a mixture, and then curing the mixture to form the composite.

Mixing

The graphene nanoribbons of the present invention may be mixed with various polymer precursors. Non-limiting examples of polymer precursors include epoxides, imides, lactic acids, glycolic acids, lactones, polyamines, acrylates, cyanoacrylates, styrenes, butadienes, and combinations thereof. In more specific embodiments, the polymer precursors are epoxides.

In addition, various methods may be used to mix graphene nanoribbons with polymer precursors. In some embodiments, the mixing may be performed manually. In some embodiments, the mixing may be performed by the use of a mechanical device, such as a mixer or a rod. In further embodiments, the mixing may be performed by sonication. In some embodiments, the mixing may involve sputtering or spraying graphene nanoribbons onto polymer precursors.

In further embodiments, graphene nanoribbons may be mixed with polymer precursors by first splitting carbon nanotubes and then sputtering the split carbon nanotubes onto the polymer precursors. Various methods may be used to split carbon nanotubes. In some embodiments, carbon nanotubes may be split by potassium or sodium metal. In some embodiments, the split carbon nanotubes may then be functionalized by various functional groups, such as alkyl groups. Additional variations of such embodiments are described in U.S. Provisional Application No. 61/534,553 entitled “One Pot Synthesis of Functionalized Graphene Nanoribbon and Polymer/Graphene Nanoribbon Nanocomposites.” Also see Higginbotham et al., “Low-Defect Graphene Oxide Nanoribbons from Multiwalled Carbon Nanotubes,” ACS Nano 2010, 4, 2059-2069. Also see Applicants' co-pending U.S. patent application Ser. No. 12/544,057 entitled “Methods for Preparation of Graphene Nanoribbons From Carbon Nanotubes and Compositions, Thin Composites and Devices Derived Therefrom.” Also see Kosynkin et al., “Highly Conductive Graphene Nanoribbons by Longitudinal Splitting of Carbon Nanotubes Using Potassium Vapor,” ACS Nano 2011, 5, 968-974.

In various embodiments, the graphene nanoribbons of the present invention may also be dissolved or suspended in one or more solvents before being mixed with polymer precursors. Examples of suitable solvents include, without limitation, acetone, 2-butanone, dichlorobenzene, ortho-dichlorobenzene, chlorobenzene, chlorosulfonic acid, dimethyl formamide, N-methyl pyrrolidone, 1,2-dimethoxyethane, water, alcohol and combinations thereof.

In further embodiments, the graphene nanoribbons of the present invention may also be associated with a surfactant before being mixed with polymer precursors. Suitable surfactants include, without limitation, sodium dodecyl sulfate (SDS), sodium dodecylbenzene sulfonate, Triton X-100, chlorosulfonic acid, and the like.

Curing

Various methods may also be used to cure a mixture containing polymer precursors and graphene nanoribbons. In some embodiments, the curing includes heating the mixture. In some embodiments, the curing temperature is under 100° C. In some embodiments, the curing temperature is about 70° C.

Curing may also be performed by the addition of a hardener to a mixture. Non-limiting examples of hardeners include amines and thiols. In some embodiments, the hardener is a polyamine. In some embodiments, the hardener may be added at around the same time that polymer precursors are mixed with graphene nanoribbons. In some embodiments, the hardener may be added after the mixing of polymer precursors with graphene nanoribbons.

Various environments may also be used for curing. In some embodiments, the curing step occurs in a vacuum or an inert atmosphere. In some embodiments, the inert atmosphere is under a stream of one or more gases, such as N₂, Ar, H₂ and combinations thereof.

In some embodiments, the curing occurs in a mold or a cast in order to produce composites of desirable shapes and sizes. In some embodiments, the curing step may also be followed by a reduction step to convert oxidized graphene nanoribbons to reduced graphene nanoribbons. In some embodiments, the reduction step can include, without limitation, treatment with heat, or treatment with a reducing agent (e.g., hydrazine, sodium borohydride, and the like). In various embodiments, heat treatment may also occur in an atmosphere, as described previously.

### Application of Composites to Substrates

In some embodiments, the composites may be applied to a substrate. In some embodiments, the application may occur before, during or after a curing step. Furthermore, various methods may be used to apply cured or pre-cured composites to substrates. Such methods may include, without limitation, chemical vapor deposition, spraying, sputtering, spin coating, blade coating, rod coating, printing, painting, mechanical transfer, and combinations of such methods. In more specific embodiments, the application may include mechanical placement of the composite onto a substrate, including roll-to-surface or roll-to-roll placement of the composite onto the substrate, or spray-on or paint-on application of the composite onto the mixture.

Furthermore, the thicknesses of the composites on the substrates may be controlled by adjusting various parameters. Such parameters may include, without limitation, composite volume, the concentration of the graphene nanoribbons in the composite, and the amount of the composite applied onto the substrate. Additional parameters that can control composite thickness include spraying parameters (e.g., spraying speed and sample-sprayer distance).

Variations

In sum, various methods may be used to form the composites of the present invention. In a more specific example, composites can be formed by dispersing graphene nanoribbons in an epoxy resin. In this example, the graphene nanoribbons can be wetted with a low boiling point solvent (e.g., acetone or 2-butanone). The epoxide phase of the resin can then added to the container with the wetted graphene nanoribbons. The mixture can then be tip sonicated for 3 minutes. Next, a hardener phase can be added to the epoxide/graphene nanoribbon mixture and tip-sonicated for 1 minute. The mixture can then be spin coated or blade coated on a substrate to form conductive films. The film can be dried in a vacuum oven at 60° C. for 12 hours to cure the mixture. Alternatively, the epoxide phase and hardener phase can be added to the graphene nanoribbons at the same time before sonication.

Advantages

The composites and methods of the present invention provide numerous advantages. For instance, the composites of the present invention generally have good conductivity. In some embodiments that are set forth in the Examples below, the composites of the present invention have conductivities between about 0.5 S/m to about 5 S/m. As also set forth in more detail below, the composites of the present invention have low resistance (e.g., 30-40 Ωcm).

Furthermore, the composites of the present invention have good adhesion properties. In particular, the composites of the present invention have shown good adhesion to many surfaces and substrates, including glass, polymers, and plastics.

In some embodiments, the composites of the present invention also require a minimal amount of graphene nanoribbons. For instance, in some embodiments, the loading of graphene nanoribbons (to form percolation conducting path) is about 0.16% (weight percentage). In other embodiments, the graphene nanoribbons may comprise about 1% to about 5% of the composite content by weight.

Furthermore, the methods of the present invention can form graphene nanoribbon composites in a facile manner that include only one or two steps and mild processing conditions. For instance, the composites of the present invention can be mixed and cured within minutes at temperatures lower than 100° C. In some embodiments, the curing may even occur at room temperature. In addition, since the starting components and reagents of the composites are generally biodegradable and non-toxic, the formed composites are environmentally friendly.

The formed composites can also be produced in a cost effective manner because the starting components are readily available at affordable prices. For instance, graphene nanoribbons made from multi-walled carbon nanotubes can be produced on a multi- gram scale in a research laboratory. In addition, several companies have been producing hundreds of tons of multi-walled carbon nanotubes per year.

Furthermore, in view of observations that many graphene nanoribbons have melting points over 2000° C. and resilience under various temperature ranges (e.g., −100 to 400° C.), Applicants envision that the formed composites of the present invention can be used effectively under various environmental conditions.

Applications

The methods and composites of the present invention also provide numerous applications. For instance, in some embodiments, the composites of the present invention can be used in the semiconductor industry to form cost effective electrical circuits and chip bonding platforms. In some embodiments, the composites of the present invention can be used to form conductive circuits and thin films on temperature sensitive substrates. In more specific embodiments, the composites of the present invention may be used as adhesives to bond computer chips.

In additional embodiments, the composites of the present invention can render typically nonconductive plastics and rubbers as conductive composite materials. Such plastic-based and rubber-based composite materials could be important in, for example, electronically monitored dampeners, seals, ram-packers and blowout preventers. The latter three applications can be particularly useful in the capture and production of oil and gas.

### Additional Embodiments

Reference will now be made to more specific embodiments of the present disclosure and experimental results that provide support for such embodiments. However, Applicants note that the disclosure below is for exemplary purposes only and is not intended to limit the scope of the claimed invention in any way.

The Examples below pertain to a highly conductive adhesive made by blending graphene nanoribbons in epoxy resins with the aid of organic functionalization of split multi-walled carbon nanotubes. Without being bound by theory, it is envisioned that the high conductivity was possible due to good macroscale percolation achieved by the highly conductive graphene nanoribbons in the nanocomposites. In addition to high conductivity reported herein, the nanocomposite is expected to have good mechanical properties due to the nearly one-dimensional nature of the graphene nanoribbons.

### EXAMPLE 1

### Synthesis of Functionalized Graphene Nanoribbons

The graphene nanoribbons were synthesized by chemical splitting of multi-walled nanotubes with NaK vapor. See, e.g., ACS Nano 5, 968-74 (2011). In a typical synthesis, 0.45 mg of NaK (1:9 by mass) was added into 100 mg multi-walled carbon nanotubes (NTL Composites) with 40 mL 1,2-dimethoxyethane (Sigma Aldrich) added as a solvent. The reaction mixture was stirred on a magnetic stirrer for at least 3 days. In order to functionalize the nanoribbons, a certain amount of electrophilic organic compounds were added and stirred for a day. The reaction mixture was washed with ethanol, H₂O, ethanol, THF, and ether in that order.

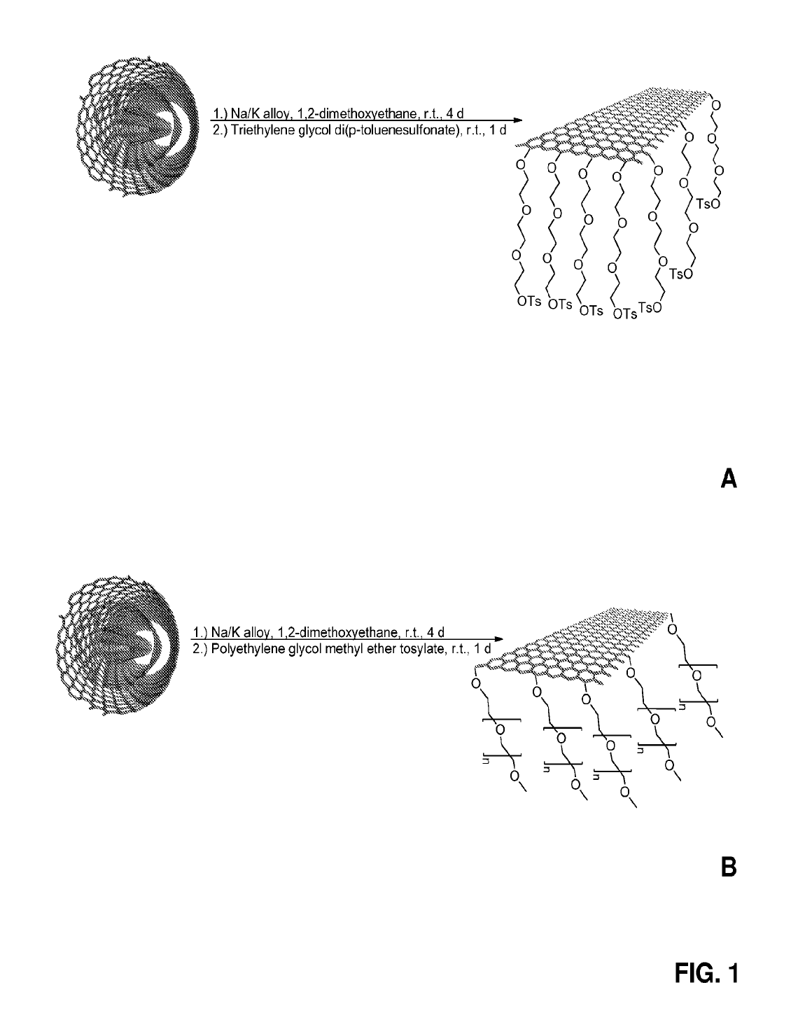

The synthetic schemes for the functionalized graphene nanoribbons are shown in FIG. 1. In this Example, two graphene nanoribbons were used. GNR1 (FIG. 1A) was functionalized with triethylene glycol di(p-toluenesulfonate). GNR2 (FIG. 1B) was functionalized with polyethylene glycol methyl ether tosylate.

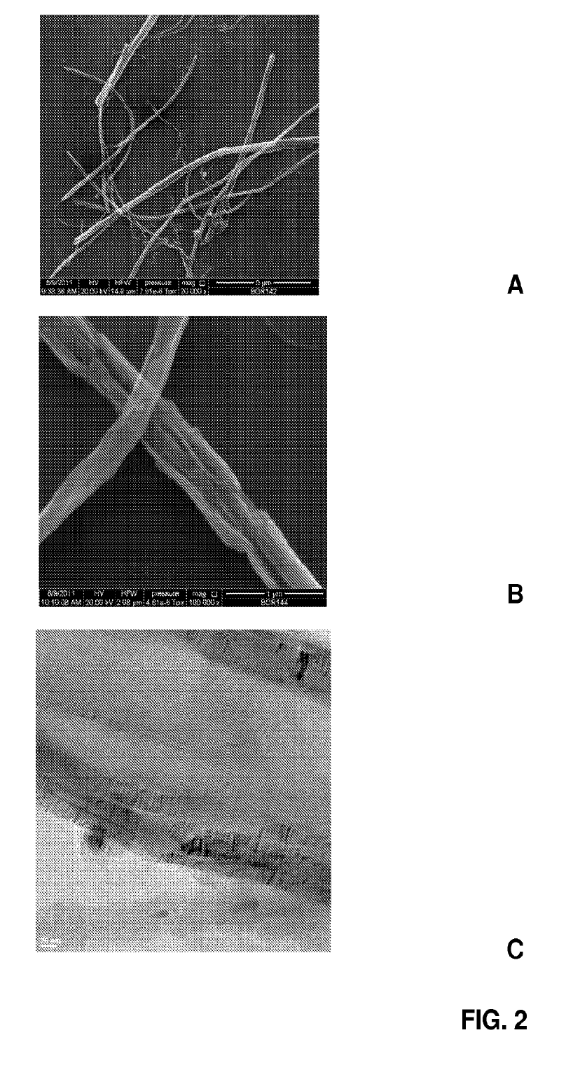

Images of the graphene nanoribbons are shown in FIG. 2. The subsequent functionalization enables better interfacial adhesion and blending with the epoxy matrix. Without being bound by theory, this is likely due to the repeating ether functionality, as non-functionalized graphene nanoribbons do not blend well with an epoxy matrix, even upon extended sonication.

In some instances, the reaction mixture was kept in a furnace at 250° C. for 14 hours. The reaction was then cooled to room temperature, opened in a dry box or in a nitrogen-filled glove bag, and then quenched with ethyl ether and ethanol. The quenched product was removed from the nitrogen enclosure and collected on a polytetrafluoroethylene (PTFE) membrane as a black, fibrillar powder.

In some instances, additional exfoliation of the graphene nanoribbons was also carried out for better dispersion. The exfoliation was carried out by using a cholorsulfonic acid treatment (i.e. the graphene nanoribbons were dispersed in chlorosulfonic acid under bath sonication for 24 hours). The mixture was quenched by pouring onto ice, and the suspension was filtered through a PTFE membrane.

### EXAMPLE 2

### Processing of Nanocomposites

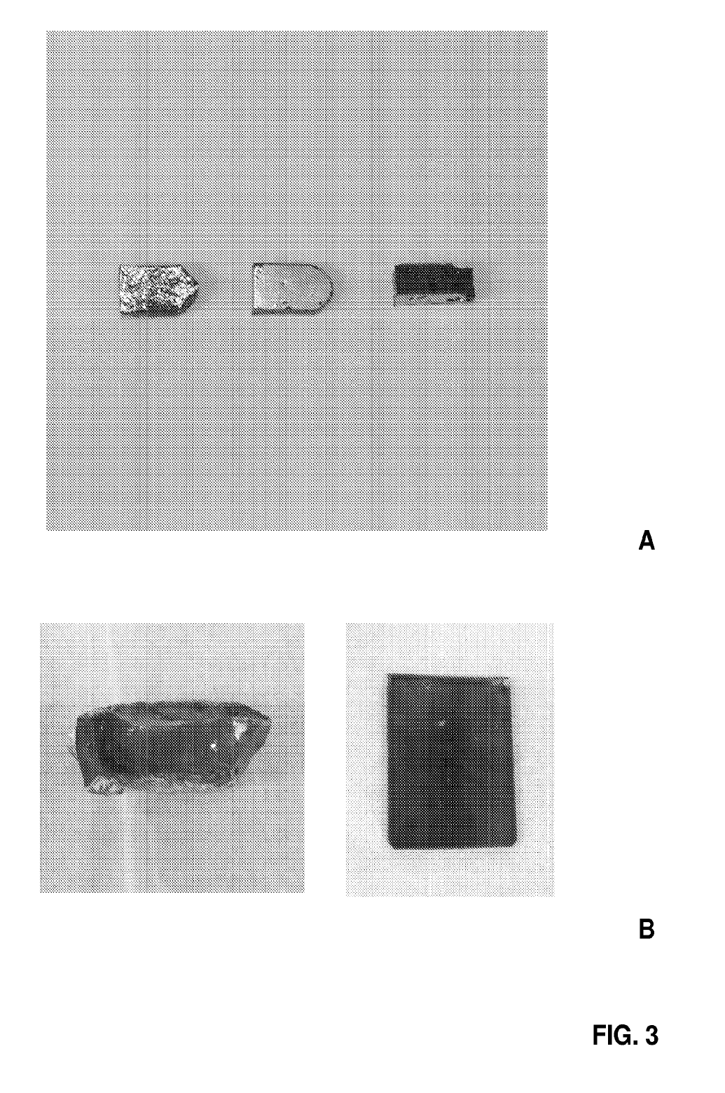

Nanocomposite samples were made by adding a certain weight percentage of functionalized graphene nanoribbons from Example 1 into an epoxy resin (Aeromarine #300). This was followed by mixing with a rod. The sample was then bath sonicated for 1 hour using a Cole-Parmer Ultrasonic Cleaner. Next, a hardener (Aeromarine #21) was added to the mixture. The mixture was then bath sonicated for 10 minutes. Thereafter, the nanocomposite mixture was cast into a silicone mold and cured for 3 hours at 70° C. on a hot plate. This process worked for any suitable epoxy/hardener combination. Images of the formed composites are shown in FIG. 3.

### EXAMPLE 3

### DC Conductivity Measurements

In order to measure conductivity of the formed nanocomposites, 70 nm Pt contacts were sputtered on the top and bottom of the nanocomposite samples in order to reduce contact resistance during measurements. Next, a CEN-TECH Digital Multimeter with a two point probe was used to measure the resistance across the sample.

Conductivity was determined from two-probe resistance measurements after taking account of the shape and size of the composite. The conductivity of the nanocomposite containing GNR 1 was 0.5 S/m (resistivity, 211.4 Ωcm) at 1.3 wt % loading and 2.4 S/m (resistivity, 41.9 Ωcm) at 3.2 wt % loading. The conductivity of the nanocomposite containing GNR 2 was 3 S/m (resistivity, 29.7 Ωcm) at 3.2 wt % loading. Because the fillers are carbon materials, the conductivity would not be adversely affected over time under room conditions.

Discussion

The results achieved herein make it promising to achieve electronic circuit bonding with carbon-based epoxy adhesives. The conductivity would be greatly enhanced with better nanocomposite processing, such as better mixing or curing of materials. For instance, the values accomplished here were produced by mere mechanical mixing with a rod, followed by sonication. Curing the composite in a vacuum or an oven with heating can afford better processing conditions. It is also envisioned that the adsorption of metallic nanoparticles on the planar graphene sheets can further enhance the electrical properties of the composites. It is also envisioned that the attachment of different kinds polymers or organic moieties to the nanoribbons would enhance electrical or mechanical properties of the composites produced there from.

Without further elaboration, it is believed that one skilled in the art can, using the description herein, utilize the present invention to its fullest extent. The embodiments described herein are to be construed as illustrative and not as constraining the remainder of the disclosure in any way whatsoever. While the preferred embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A composite, comprising:
a polymer matrix; and
graphene nanoribbons dispersed in the polymer matrix.

2. The composite of claim 1, wherein the graphene nanoribbons are selected from the group consisting of functionalized graphene nanoribbons, pristine graphene nanoribbons, doped graphene nanoribbons, graphene oxide nanoribbons, reduced graphene oxide nanoribbons, and combinations thereof.

3. The composite of claim 1, wherein the graphene nanoribbons comprise functionalized graphene nanoribbons.

4. The composite of claim 3, wherein the graphene nanoribbons are functionalized with functional groups selected from the group consisting of polyethylene glycols, aryl groups, hydroxyl groups, carboxyl groups, phenol groups, phosphonic acids, amine groups, and combinations thereof.

5. The composite of claim 1, wherein the graphene nanoribbons comprise stacked graphene nanoribbons.

6. The composite of claim 1, wherein the graphene nanoribbons comprise graphene nanoribbons derived from split multi-walled carbon nanotubes.

7. The composite of claim 1, wherein the polymer matrix comprises polymers selected from the group consisting of polyurethanes, epoxy resins, polyimides, nylons, polyesters, acrylic resins, polycyanoacrylates, polystyrenes, polybutadienes, synthetic rubbers, natural rubbers and combinations thereof.

8. The composite of claim 1, wherein the polymer matrix is an epoxy polymer matrix.

9. The composite of claim 1,
wherein the polymer matrix is an epoxy polymer matrix, and
wherein the graphene nanoribbons comprise functionalized graphene nanoribbons.

10. The composite of claim 1, further comprising metals.

11. The composite of claim 10, wherein the metals are selected from the group consisting of tin, copper, gold, silver, aluminum and combinations thereof.

12. The composite of claim 1, wherein the composite is electrically conductive.

13. The composite of claim 12, wherein the composite has an electrical conductivity of between about 0.5 S/m to about 500 S/m.

14. A method of making a composite, wherein the method comprises:
mixing graphene nanoribbons with polymer precursors to form a mixture; and
curing the mixture to form the composite.

15. The method of claim 14, wherein the curing step comprises heating the mixture.

16. The method of claim 15, wherein the heating occurs under 100° C.

17. The method of claim 14, wherein the curing step comprises adding a hardener to the mixture.

18. The method of claim 14, wherein the graphene nanoribbons are selected from the group consisting of functionalized graphene nanoribbons, pristine graphene nanoribbons, doped graphene nanoribbons, graphene oxide nanoribbons, reduced graphene oxide nanoribbons, and combinations thereof.

19. The method of claim 14, wherein the graphene nanoribbons comprise functionalized graphene nanoribbons.

20. The method of claim 14, wherein the graphene nanoribbons comprise graphene nanoribbons derived from split multi-walled carbon nanotubes.

21. The method of claim 14, wherein the polymer precursors are selected from the group consisting of epoxides, imides, lactic acids, glycolic acids, lactones, polyamines, acrylates, cyanoacrylates, styrenes, butadienes, and combinations thereof.

22. The method of claim 14, wherein the polymer precursors comprise an epoxide.
